(19) United States
(12) Patent Application Publication
(10) Pub. No.: US 2012/0181755 A1
(43) Pub. Date: Jul. 19, 2012

(54) SUMPSEALER

(76) Inventor: Thomas Edward Schaefer, Dekalb, IL (US)

(21) Appl. No.: 12/930,657

(22) Filed: Jan. 14, 2011

(51) Int. Cl. F16L 25/00

(52) U.S. Cl. 277/627; 277/602

(57) ABSTRACT

Many existing sump covers have large access slots to accommodate the location of the sump pump discharge pipe. The exposed slot can allow undesirable soil gases to enter a home.

The SUMPSEALER is a retrofit device that:
1) Uses a one piece reversible attachment to cover both sides of the slot simultaneously.
2) A mating part is used to cover the area around one or more electrical cords and position the cord(s) next to the pipe.
3) Both parts are clear and serve as a “viewport” enabling visual inspection without removal of sump cover.
4) By using caulk or sealant and utilizing the SUMPSEALER device, the existing sump cover can seal out undesirable soil gases.

This device is comprised of two mating parts used in conjunction with a slotted sump cover.

The two parts fit around the sump discharge pipe and cover the slot opening on either or both sides of the pipe simultaneously.

### DESCRIPTION

A retrofit clear one-piece reversible SLOT SEAL, (item 14) and clear CORD SEAL, (item 16) are positioned around the sump pump discharge pipe and parallel to the elongated slot of sump cover.

The SLOT SEAL covers the slot openings on either or both sides of the sump pump discharge pipe simultaneously.

The triangular area(s) of the CORD SEAL can be trimmed, providing an opening for one or more electrical cords to exit the sump basin.

### DRAWING DESCRIPTION

FIG. 1: is a system schematic of the invention.

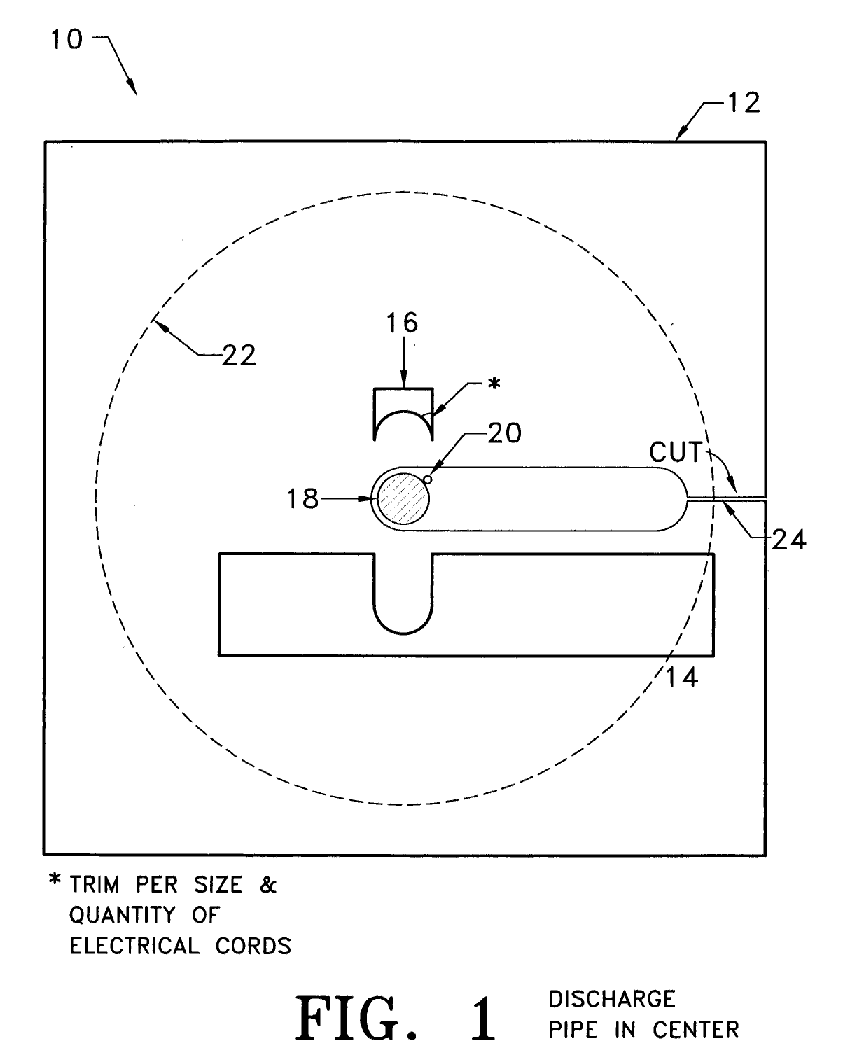

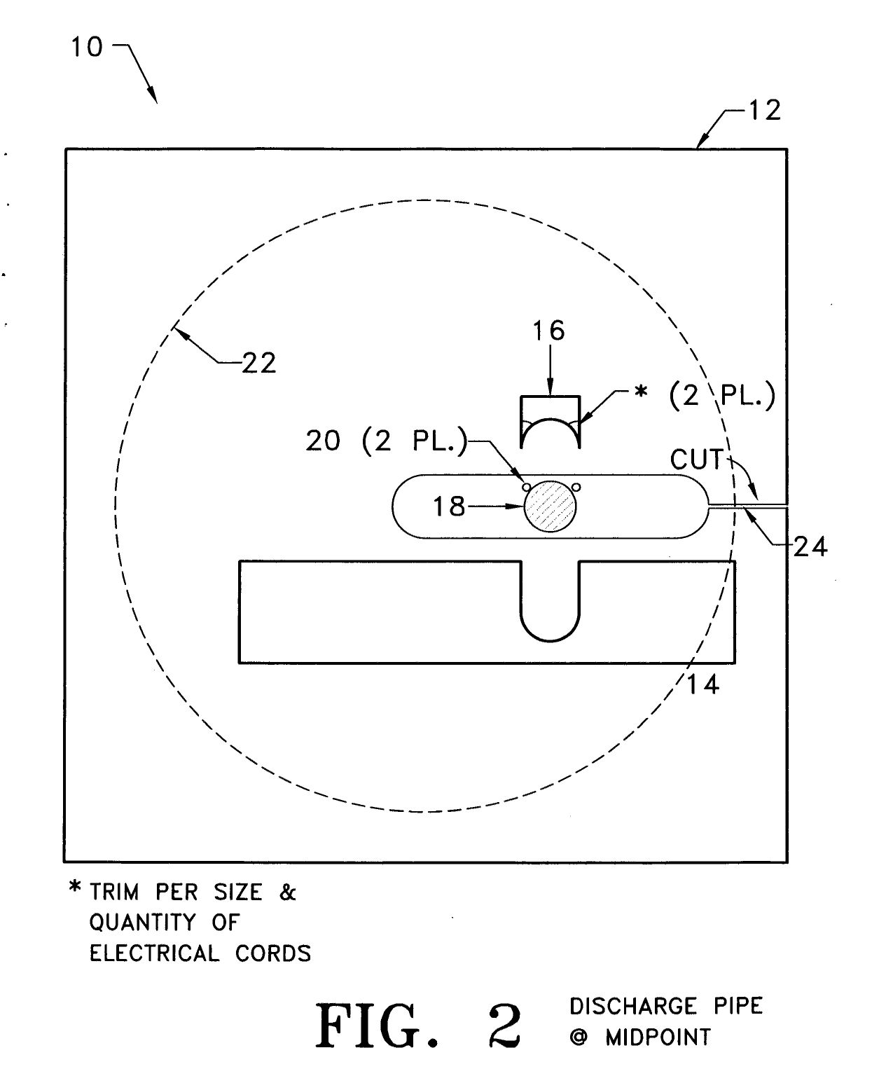

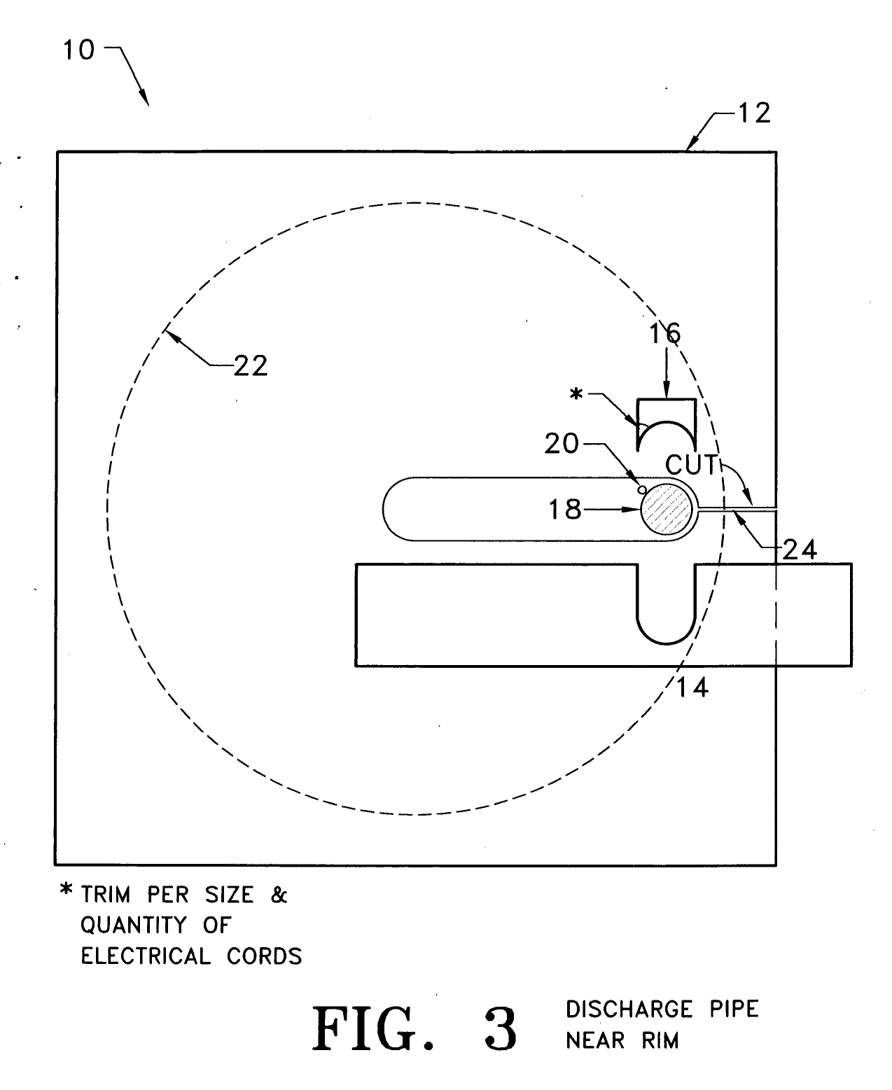

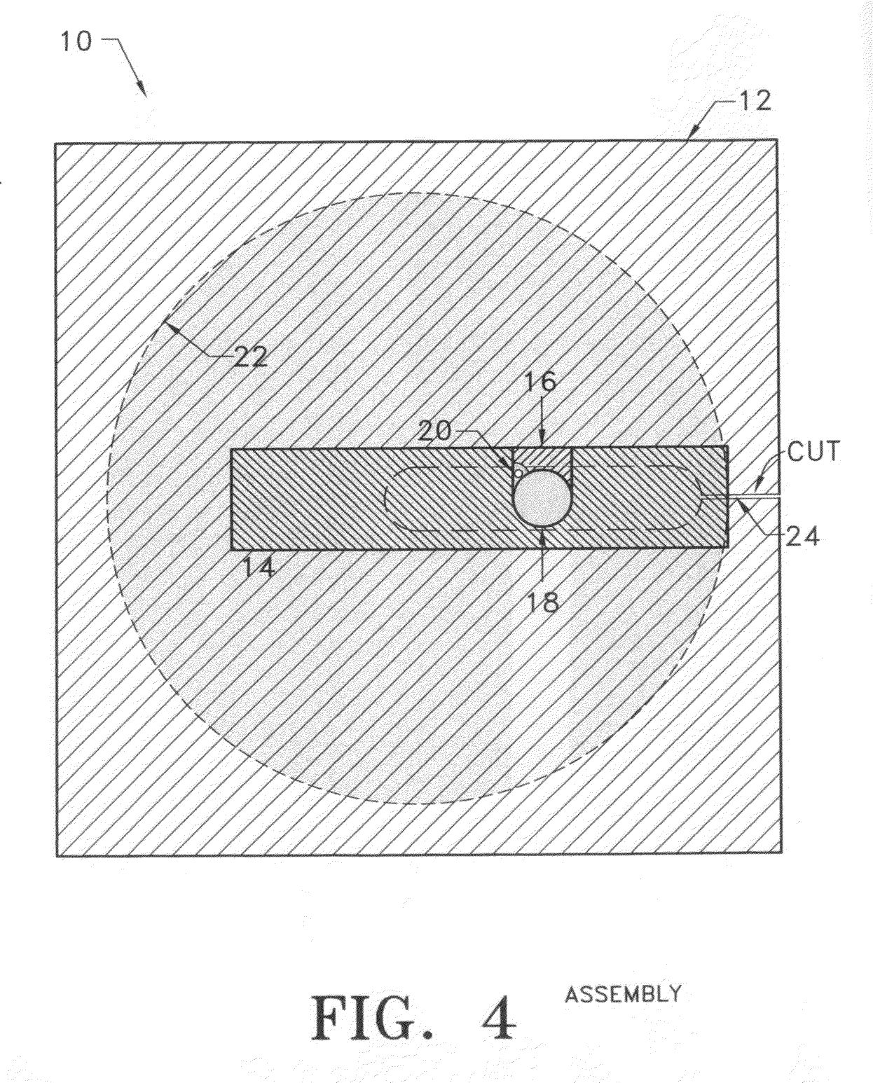

### DESCRIPTION LIST

10: is the overall invention.

12: is the sump cover.

14: is the SLOT SEAL.

16: is the CORD SEAL.

18: is the sump pump discharge pipe.

20: is the sump pump electrical cord(s).

22: is the sump basin.

24: is the “cut” allowing the sides to separate and flex around the sump pump discharge pipe.

What is claimed is:

1. A retrofit clear one-piece reversible attachment (SLOT SEAL, item 14) that follows the position of the sump discharge pipe and covers both slot openings simultaneously.

2. An insert (CORD SEAL, item 16) placed into the SLOT SEAL covers the cord openings not used.

3. Using clear plastic or similar strength materials, both parts serve as “view ports” enabling visual inspection without removal of sump cover.
